(19) United States
(12) Patent Application Publication
(10) Pub. No.: US 2015/0104672 A1
(43) Pub. Date: Apr. 16, 2015

(54) SAFETY DEVICE OF LITHIUM-ION BATTERY

(71) Applicant: NingDe Contemporary Amperex Technology Limited, Ningde City (CN)

(72) Inventors: Rulai Cai, Ningde City (CN); Qiong Qu, Ningde City (CN); Quankun Li, Ningde City (CN); Peng Wang, Ningde City (CN); Pinghua Deng, Ningde City (CN)

(73) Assignee: NingDe Contemporary Amperex Technology Limited, Ningde City (CN)

(21) Appl. No.: 14/055,260

(22) Filed: Oct. 16, 2013

(51) Int. Cl. H01M 2/34; H01M 10/0525

(52) U.S. Cl. CPC H01M 2/345; H01M 10/0525; H01M 2200/20
USPC 429/7

(57) ABSTRACT

This invention belongs to the lithium-ion battery field, and in particular, to a safety device of a lithium-ion battery. The safety device of a lithium-ion battery comprises a top cover plate, a first electrode post, a second electrode post, an explosion-proof valve, and a conductive plate, wherein the first electrode post, the second electrode post, and the explosion-proof valve are respectively positioned on the top cover plate; the first electrode post is electrically connected to the top cover plate; the second electrode post is assembled in an insulated way to the top cover plate; and the second electrode post is electrically connected to the conductive plate; where an air-pressured flip plate is further positioned on the top cover plate, and a cut is positioned on the air-pressured flip plate. The device may be used to avoid a safety problem caused by overcharging when an accident occurs on a cell, and release energy of the faulty cell through an outer short-circuit, thereby avoiding a more serious safety accident and ensuring safety performance of the battery.

### TECHNICAL FIELD OF THE INVENTION

This invention relates to the lithium-ion battery field, and in particular, to a safety device of a lithium-ion battery.

### BACKGROUND OF THE INVENTION

With the development of modern society and the enhancement of people's environmental protection awareness, a rechargeable secondary battery is selected as a power source for more and more devices, such as a mobile phone, a notebook computer, an electric tool, and an electric vehicle, which provides a large space for applying and developing a rechargeable secondary battery.

An electric vehicle, an energy storage power station, and the like generally need to use a power battery having high capacity as a power source. These power batteries, besides the high capacity, should also have good safety performance and a long cycle life, so as to meet use criteria and satisfy people's requirements.

In order to ensure safety performance for a power battery to a certain extent, generally, a pressure relief valve is installed on a top cover of the battery. When the battery is recharged improperly, short-circuited, or exposed to an adverse environment such as a high temperature and causes an accident, the high-capacity battery may generate a large amount of gas and a temperature may increase sharply, where the gas forces the pressure relief valve to open to achieve the purpose of releasing the pressure. The provision of the pressure relief valve may improve the safety performance for the battery to a certain extent. However, the energy accumulated in the battery itself on which the accident occurs cannot be released, and the battery itself becomes a potential threat, which produces a certain safety problem. Moreover, if the battery is further overcharged after the accident occurs, a more serious safety accident may be caused.

The invention patent of the application No. 201010171095.5 provides a rechargeable battery. The battery improves, by short-circuiting outside electrodes and maintaining the short-circuit state, the safety performance when it is being overcharged. In the prior art, all batteries have an explosion-proof device. There is a possibility of electrolyte ejection, burning, and explosion for a battery without an explosion-proof device, which is very dangerous. However, a battery with a safety protection device is also very dangerous because a short-circuit component may be damaged and hazardous energy may be not released in a timely manner.

### SUMMARY OF THE INVENTION

This invention aims to, with respect to the defects of the prior art, provide a safety device of a lithium-ion battery, where the device may avoid a safety problem caused by overcharging when an accident occurs on a cell on one hand, and may release energy of the faulty cell through an outer short-circuit on the other hand, thereby avoiding a more serious safety accident and ensuring safety performance of the battery.

To fulfill such objectives, this invention employs the following technical solution: a safety device of a lithium-ion battery includes a top cover plate, a first electrode post, a second electrode post, an explosion-proof valve, and a conductive plate; the first electrode post, the second electrode post, and the explosion-proof valve are respectively positioned on the top cover plate; the first electrode post is electrically connected to the top cover plate; the second electrode post is assembled in an insulated way to the top cover plate; and the second electrode post is electrically connected to the conductive plate, where an air-pressured flip plate is further positioned on the top cover plate, and a cut is positioned on the air-pressured flip plate.

The first electrode post is electrically connected to the top cover plate by welding or riveting.

The second electrode post is assembled in an insulated way to the top cover plate by molding.

Transit plates are positioned respectively below the first electrode post and the second electrode post, and the transit plates are electrically connected respectively to the first electrode post and the second electrode post.

The top cover plate is rectangle-shaped, circle-shaped, or oval-shaped.

A hole is positioned on the top cover plate, and the air-pressured flip plate is positioned within the hole in a sealed way by laser welding.

A cross section of the air-pressured flip plate is circle-shaped.

Thickness of the cut is 0.05-2 mm.

Thickness of the cut is 0.1-1 mm.

The benefits of the invention are that: this invention includes a top cover plate, a first electrode post, a second electrode post, an explosion-proof valve, and a conductive plate; the first electrode post, the second electrode post, and the explosion-proof valve are positioned respectively on the top cover plate; the first electrode post is conductively connected to the top cover plate; the second electrode post is assembled in an insulated way to the top cover plate; the second electrode post is conductively connected to the conductive plate; an air-pressured flip plate is further positioned on the top cover plate; and a cut is positioned on the air-pressured flip plate; where the air-pressured flip plate requires a low air pressure for flipping and may flip immediately when a defined air pressure is achieved, thereby forming a safe short circuit for the battery. The device may be used to avoid a safety problem caused by overcharging when an accident occurs on a cell, and release energy of the faulty cell through an outer short-circuit, thereby avoiding a more serious safety accident and ensuring safety performance of the battery.

### BRIEF DESCRIPTION OF DRAWINGS

FIG. 1 is a schematic structural diagram of the invention; and

FIG. 2 is an enlarged view of portion A of FIG. 1.

Where: 1—conductive plate, 2—transit plate, 3—second electrode post, 4—first electrode post, 5—hole, 6—explosion-proof valve, 7—top cover plate, 8—air-pressured flip plate, and 9—cut.

### DETAILED DESCRIPTION OF PREFERRED EMBODIMENTS

The following further describes this invention in detail with reference to embodiments and accompanying drawings of the specification; however, a specific implementation mode of this invention is not limited thereto.

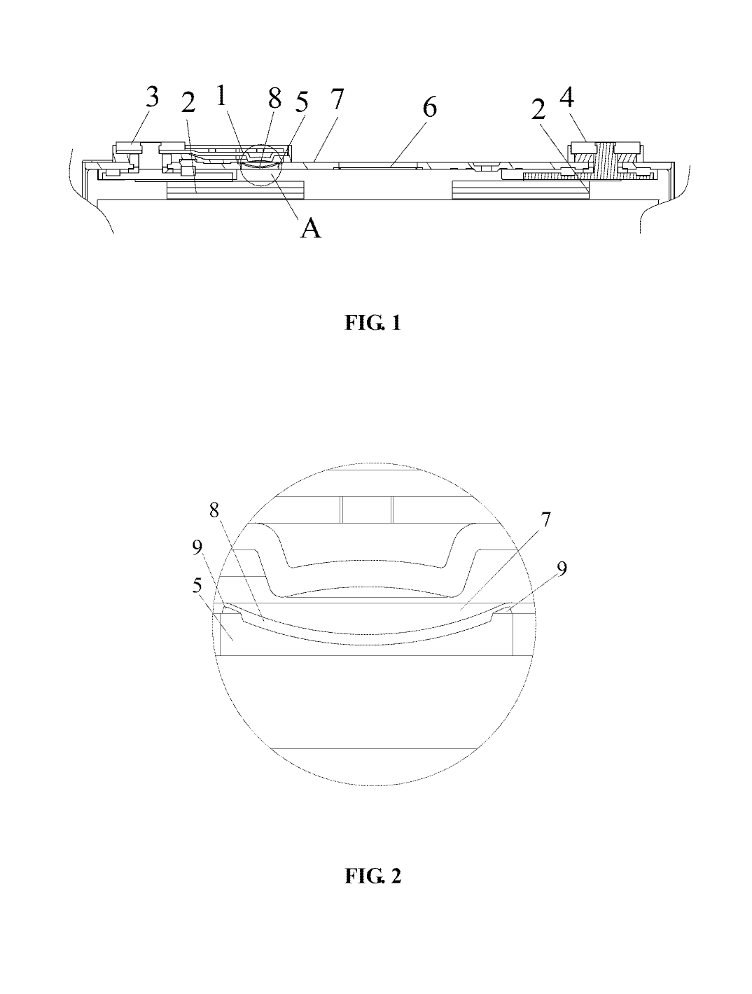

As shown in FIGS. 1 and 2, a safety device of a lithium-ion battery includes a top cover plate 7, a first electrode post 4, a second electrode post 3, an explosion-proof valve 6, and a conductive plate 1; the first electrode post 4, the second electrode post 3, and the explosion-proof valve 6 are respectively positioned on the top cover plate 7; the first electrode post 4 is electrically connected to the top cover plate 7; the second electrode post 3 is assembled in an insulated way to the top cover plate 7; the second electrode post 3 is electrically connected to the conductive plate 1; an air-pressured flip plate 8 is further positioned on the top cover plate 7; and a cut 9 is positioned on the air-pressured flip plate 8, where the air-pressured flip plate 8 flips under an air pressure of 0.3-0.5 MPa and will not break under the air pressure of 0.7 MPa, and a flipping height is not smaller than 0.5 mm.

Preferably, the first electrode post 4 is electrically connected to the top cover plate 7 by welding or riveting, where a material of the top cover plate 7 is aluminum alloy or stainless steel.

Preferably, the second electrode post 3 is assembled in an insulated way to the top cover plate 7 by molding.

Preferably, transit plates 2 are positioned respectively below the first electrode post 4 and the second electrode post 3, and the transit plates 2 are electrically connected respectively to the first electrode post 4 and the second electrode post 3.

Preferably, the top cover plate 7 is rectangle-shaped, circle-shaped, or oval-shaped, where the shape of the top cover plate 7 may be determined according to the actual use.

Preferably, a hole 5 is positioned on the top cover plate 7, and the air-pressured flip plate 8 is positioned within the hole 5 in a sealed way by laser welding.

A cross section of the air-pressured flip plate 8 is arc-shaped.

Preferably, the thickness of the cut 9 is 0.05-2 mm.

The thickness of the cut 9 is 0.1-1 mm. Typically, the thickness of the cut 9 is around 0.25 mm because an adjustment of the thickness may improve a flipping air pressure. The flip plate having the cut 9 is fixedly connected to edges of the hole 5 all around, where a thicker cut 9 requires a lower air pressure for the air-pressured flip plate 8 to flip.

An accident occurring on a cell will definitely cause an air pressure and temperature inside the cell to increase; when the internal air pressure increases to a flipping pressure of the air-pressured flip plate 8, the air-pressured flip plate 8 flips immediately to contact the conductive plate 1, thereby forming an outer short-circuit so that a cathode and an anode of the battery contact each other for discharging by using a safe short circuit, so as to ensure safety of the battery.

According to what is disclosed and revealed herein, persons skilled in the field of the invention can make variations and modifications to the foregoing implementation modes. Therefore, this invention is not limited to the above specific implementation modes. Any obvious improvements, replacements, or variations made by persons skilled in the art on the basis of the invention shall fall within the protection scope of the invention. In addition, although specific terms are employed herein, the terms are merely for ease of description and do not constitute any limitation on the invention.

What is claimed is:

1. A safety device of a lithium-ion battery, comprising a top cover plate (7), a first electrode post (4), a second electrode post (3), an explosion-proof valve (6), and a conductive plate (1), wherein the first electrode post (4), the second electrode post (3), and the explosion-proof valve (6) are respectively positioned on the top cover plate (7); the first electrode post (4) is electrically connected to the top cover plate (7); the second electrode post (3) is assembled in an insulated way to the top cover plate (7); and the second electrode post (3) is electrically connected to the conductive plate (1), wherein: an air-pressured flip plate (8) is further positioned on the top cover plate (3), and a cut (9) is positioned on the air-pressured flip plate (8).

2. The safety device of a lithium-ion battery according to claim 1, wherein: the first electrode post (4) is electrically connected to the top cover plate (7) by welding or riveting.

3. The safety device of a lithium-ion battery according to claim 1, wherein: the second electrode post (3) is assembled in an insulated way to the top cover plate (7) by molding.

4. The safety device of a lithium-ion battery according to claim 1, wherein: transit plates (2) are positioned respectively below the first electrode post (4) and the second electrode post (3), and the transit plates (2) are electrically connected respectively to the first electrode post (4) and the second electrode post (3).

5. The safety device of a lithium-ion battery according to claim 1, wherein: the top cover plate (7) is rectangle-shaped, circle-shaped, or oval-shaped.

6. The safety device of a lithium-ion battery according to claim 1, wherein: a hole (5) is positioned on the top cover plate (7), and the air-pressured flip plate (8) is positioned within the hole (5) in a sealed way by laser welding.

7. The safety device of a lithium-ion battery according to claim 1, wherein: a cross section of the air-pressured flip plate (8) is arc-shaped.

8. The safety device of a lithium-ion battery according to claim 1, wherein: thickness of the cut (9) is 0.05-2 mm.

9. The safety device of a lithium-ion battery according to claim 8, wherein: thickness of the cut (9) is 0.1-1 mm.
